(19) United States
(12) Patent Application Publication
(10) Pub. No.: US 2011/0009290 A1
(43) Pub. Date: Jan. 13, 2011

(54) Methods for Identifying One or More Bioactive Genes

(75) Inventors: Marco Kruijt, Ede (NL); Josephus Maria Raaijmakers, Rhenen (NL)

Correspondence Address: THE WEBB LAW FIRM, P.C., 700 KOPPERS BUILDING, 436 SEVENTH AVENUE, PITTSBURGH, PA, 15219, US

(73) Assignee: WAGENINGEN UNIVERSITEIT, Wageningen (NL)

(21) Appl. No.: 12/919,113

(22) PCT Filed: Feb. 27, 2008
(86) PCT No.: PCT/EP08/01525

§ 371 Date: Aug. 24, 2010

(30) Foreign Application Priority Data
Feb. 25, 2008 (KR) 10-2008-0016684

(51) Int. Cl. C40B 30/06

(52) U.S. Cl. 506/10

(57) ABSTRACT

The present invention relates to methods for identifying one or more bioactive genes, comprising: (a) introducing an expressible genomic DNA library derived from a first organism or a group of first organisms into a second organism, wherein said genomic DNA library is comprised in a copy inducible vector in said second organism; (b) growing said multitude of clones of said second organism at a low copy number of said vector and at high copy number of said vector; (c) identifying one or more clones of said second organism wherein said identification comprises identifying altered growth characteristic; and (d) identifying in the one or more clones of said second organism identified in step (c) one or more genes of said first organism or said group of first organisms providing the altered growth characteristic, thereby identifying the one or more bioactive genes.

The present invention relates to methods for identifying one or more bioactive genes. The present invention especially relates to high-through put methods for identifying one or more bioactive genes in a first organism, or group of first organisms, with antibiotic activity against a second organism.

The increased use of antibiotics has led to resistance development in (human) pathogenic micro-organisms (Nordmann et al. 2007; Cegelski et al. 2008). This antibiotic resistance, and more specifically multidrug resistance (MDR), has increased the demand for novel pathogen control measures and antibiotics, in particular novel classes of antibiotics that are chemically unrelated to currently used antibiotic compounds (McDevitt and Rosenberg, 2001; Cegelski et al. 2008).

In addition, more fundamental knowledge is required to better understand which genes, mechanisms and cellular processes play a key role in antibiotic biosynthesis and resistance (Alekshun and Levy 2007).

Living (micro)organisms are an important resource for the isolation and discovery of novel antibiotics and other bioactive compounds, including therapeutics and enzymes with diverse functions (Handelsman et al. 1998; Cowan, 2000; McDevitt and Rosenberg, 2001).

Suitable detection methods, and especially high throughput detection methods, are crucial for the identification of novel antibiotic compounds and other unknown bioactive molecules in organisms.

Most of the known isolation procedures or detection methods are based on culturing an organism to enable production of potential bioactive compounds, which are then extracted, isolated, and characterized in detail.

This methodology has been adopted for compounds produced by many culturable (micro)organisms and the chances of identifying novel bioactive molecules have decreased considerably over the past decade. However, most microorganisms (>90%) cannot be cultured using currently available laboratory procedures and techniques.

Meta-genomic libraries (genomic DNA derived from the collective genomes of microorganisms present in a sample) are comprised of random DNA fragments from both culturable and non-culturable micro-organisms cloned into a vector. This allows the expression of the cloned DNA fragments. When such library is transferred into a culturable host, also compounds from non-culturable micro-organisms can be detected, isolated, produced and characterized (Handelsman et al. 1998; Steele and Streit, 2005; Leveau, 2007). This dramatically increases the number of sources potentially providing bioactive compounds, and especially antibiotics.

After constructing the (meta)genomic library, the activity of crude or partially purified compounds can then be tested against a panel of target organisms (e.g. human pathogenic bacteria, fungi). This requires an effective screening method in which the activity of the compounds produced by each individual clone needs to be tested against one or multiple target organisms, procedures which usually are extremely laborious and costly.

Therefore there is a need in the art for methods allowing fast and efficient screening, preferably high-through put screening, of genomic DNA libraries, and especially meta-genomic DNA libraries (a genomic DNA library of a group of organisms) for bioactive genes and particularly genes encoding proteins having an antibiotic activity or capable of providing compounds with an antibiotic activity.

It is an object of the present invention, amongst others, to provide such method.

According to the present invention this object, amongst other objects, is met by a method as defined in the appended claim 1.

Especially, this object, amongst other objects, is met by a method for identifying one or more bioactive genes, comprising:

(a) introducing an expressible genomic DNA library derived from a first organism, or a group of first organisms, into a second organism, wherein said genomic DNA library is comprised in a, in said second organism, copy inducible vector, thereby providing a multitude of clones of said second organism capable of expressing at least a part of said genomic DNA library;

(b) growing said multitude of clones of said second organism at a low copy number of said vector and at high copy number of said vector;

(c) identifying one or more clones of said second organism wherein said identification comprises identifying altered growth characteristic(s) between a clone of said second organism grown at a low copy number of said vector and at high copy number of said vector;

(d) identifying in the one or more clones of said second organism identified in step (c) one or more genes of said first organism or said group of first organisms providing the altered growth characteristic(s), thereby identifying the one or more bioactive genes.

An expressible genomic DNA library can be readily obtained using standard techniques known to the skilled person. For example, genomic DNA can be isolated from a single (culturable) organism or a group of both culturable and non-culturable organisms present in, for example, a soil sample, a marine sample or a sample of the gastrointestinal tract of a human or an animal.

With respect to the latter genomic DNA, such genomic DNA is also designated as a meta-genomic DNA and protocols to obtain high quality genomic DNA from metasystems are readily available and have previously been described in detail (Osoegawa et al. 1998; Béjá et al. 2000; reviewed in Handelsman et al. 1998; Leveau, 2007).

This (meta)genomic DNA can then be fragmented, for example by shearing or treating the genomic DNA with restriction enzymes, and the fragments obtained can be cloned in a copy-inducible vector such as a fosmid or BAC vector, several of which have been previously described and can be used in a variety of microorganisms, including Gram-positive and Gram-negative bacteria (Sukchawalit et al. 1999; Wild and Szybalski, 2004a, 2004b; Charpentier et al. 2004; Kim and Mills, 2007).

The choice of a specific copy-inducible vector is dependent on the second organism or target organism selected. This because, in order to be expressible, the copy-inducible vector should be at least capable of replicating in the second organism within the context of the present invention.

According to the present invention, the copy-inducible vector, besides comprising replication control elements operable in the second organism, can also comprise additional elements such as expression control elements such as a promoter, a terminator and/or transcription enhancing elements; selection elements such as antibiotic or nutrient complementing elements; and any other element allowing, or facilitating, replication, selection and/or expression of the copy-inducible vector in the second organism.

The copy inducible vector comprising the (meta)genomic DNA can be introduced in the second organism using any suitable transformation or transfection technique, known to the skilled person, such as electroporation, bacterium or virus facilitated transformation, protoplast transformation, etc.

After transforming or transfecting the second organism with the present copy-inducible vector, a multitude of clones of said second organism are obtained capable of at least partly expressing the genomic DNA derived from the first organism(s).

According to step (b) of the present invention, these multitude of clones of said second organism capable of at least partly expressing the (meta)genomic DNA derived from the first organism(s) are subsequently grown under conditions providing a low copy number of the copy number inducible vector and under conditions allowing a high copy number of the copy number inducible vector.

For example, a duplicate 96-wells microtiter plate can be used to grow individual or a pool of clones of the second organism, wherein the first plate provides growth conditions allowing a low copy number and the second plate provides growth conditions allowing a high copy number.

After a suitable growth period, the growth characteristic(s) of a clone, or pool of clones, can be readily determined by comparing the corresponding wells, i.e., growth at low and high copy number, in the microtiter plates.

Since any observed altered growth characteristic between both wells is at least partially, or inherently, attributable to the increased expression of the fragment of (meta) genomic DNA comprised⁻in the clone, or pool of clones, through the increased copy number, the products of the expressed gene(s) in this (meta)genomic DNA fragment have bioactive properties in the second organism such as antibiotic properties.

By subsequently isolating and, for example sequencing, the (meta)genomic DNA fragment(s) comprised in the clone(s) showing altered growth characteristics, one or more bioactive genes, preferably antibiotic genes, comprised in the first organism or the group of first organisms are identified.

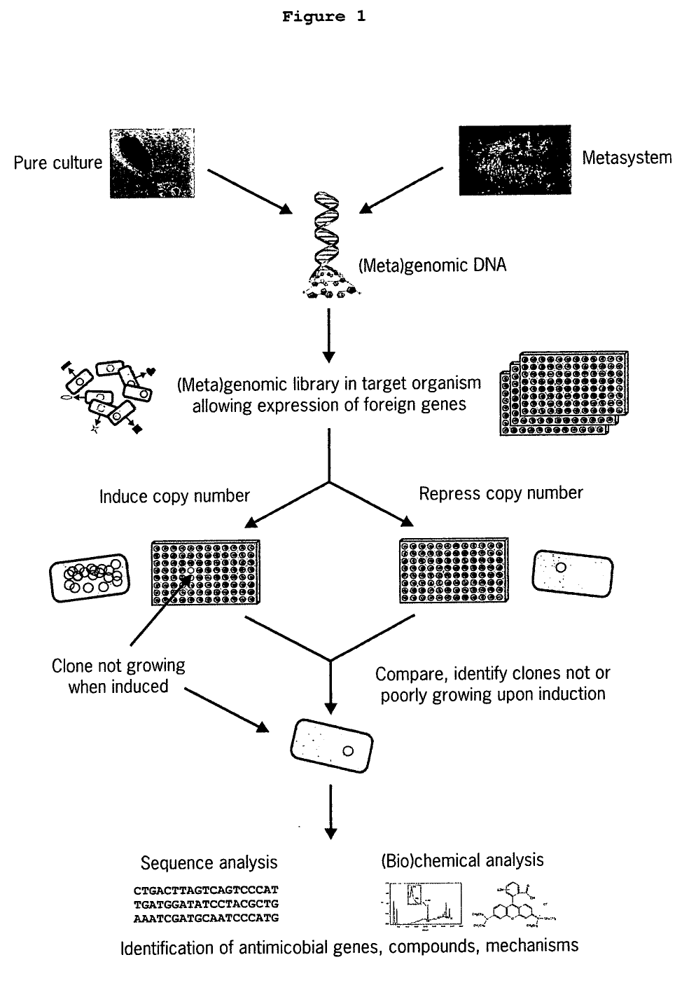

The above method is schematically exemplified in the appended FIG. 1. According to FIG. 1, (meta)genomic DNA, isolated from a pure culture or a metasystem, is isolated and cloned into a copy-inducible vector.

The (meta)genomic library is then transferred into the target organism (e.g. a pathogenic bacterium). Subsequently, the copy-number of the vector harboring the (meta)genomic DNA is induced or not induced and the effects of the induction on the growth of the target organism are monitored for each of the individual clones.

Those clones that exhibit a consistent adverse effect on growth or cause lysis of the target organism are further characterized by molecular and biochemical methods to identify the bioactive genes, antimicrobial mechanisms and compounds.

According to a preferred embodiment of the present invention, assessment of growth characteristic alterations between the induced and non-induced clone, or pool of clones, is determined by visual inspection of the growth.

It is contemplated within the context of the present invention that the term “visual inspection” encompasses both visual inspection using the naked eye and visual inspection using standard laboratory means allowing determining the optical density, wavelength absorption/emission, and/or turbidity.

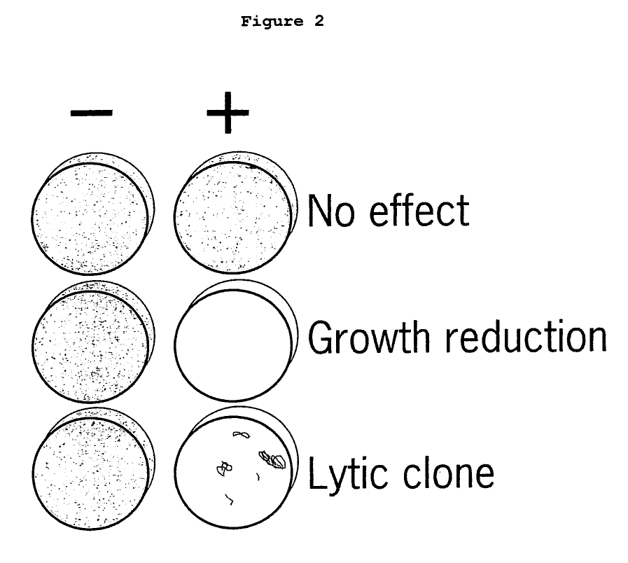

A schematic example of a suitable visual inspection within the context of the present invention is provided in FIG. 2. In FIG. 2, the − sign column indicates growth of a clone of the transformed or transfected second organism at low copy numbers and the + sign column indicated growth of the transformed or transfected second organism at high copy numbers. As shown in FIG. 2, suitable visual indicators of altered growth characteristics are, as compared with low copy number growth, a growth reduction or inhibition, no growth or a lytic growth.

Therefore, according to a preferred embodiment, in step (c) of the methods according to the present invention, the altered growth characteristic(s) at high copy number, as compared to the growth characteristics at low copy number, are selected from the group consisting of a reduced growth; cell lysis; and no growth.

According to a particularly preferred embodiment of the present invention the second organism is a microorganism, preferably a pathogenic microorganism selected from the group consisting of bacteria, yeasts, fungi, nematodes, lower eukaryotes, and unicellular organisms.

Considering the required growth of the second microorganism according to the present invention, the selected second organism is preferably an organism which can be grown or cultured using readily available standard laboratory equipment such as an incubator and media.

Considering that microorganisms are considered a rich source of potential bioactive genes, also the first organism or the group of first organisms is/are microorganism(s), preferably selected from the group consisting of bacteria, yeasts, fungi, nematodes, lower eukaryotes, and unicellular organisms.

However, within the context of the present invention, it is contemplated that also higher organisms as plants, insects, animals, and mammals can provide a valuable source of (meta)genomic DNA libraries.

According to a preferred embodiment of the invention, the present methods, further comprise, after step (e), isolating said one or more bioactive genes.

Such isolation according to the present invention can comprise a further subcloning of the meta(genomic) DNA fragments identified and/or sequencing the fragments. Also the fragments can be further expressed using suitable expression systems, either intracellular or extracellular, such as bacterium, yeast, mammal and insect expression systems thereby providing suitable amounts of the expression products to be used for further analysis or production.

In a particularly preferred embodiment of the present invention, the identified one or more bioactive genes encode proteins having an antibiotic activity for, amongst others, the second organism or are capable of providing compounds with an antibiotic activity for said second organism.

A compound with an antibiotic activity within the context of the present invention is defined as “a substance produced by, or semisynthetic substance derived from, an organism, preferably a microorganism, and able to inhibit or kill a microorganism”.

With respect to “capable of providing compounds with an antibiotic activity”, for example, the identified gene(s) can encode enzyme(s) allowing the conversion of metabolic products into antibiotics or they can encode proteins indirectly influencing or facilitating, through intermediate mechanisms or compounds, the conversion of metabolic products into antibiotics

Although the terms “high copy number” and “low copy number”, as used in the present context, are relative terms indicating a copy number obtained with a non-induced copy-inducible vector, i.e., a low copy number, as compared with the copy number of, the same, induced copy-inducible vector, i.e., a high copy number, a general indication, although dependent on the nature of the specific copy-inducible vector used, a low copy number can be regarded as 1 to 5 copies per cell, such as 1 to 4, 1 to 3, 1 to 2 or 1 copies per cell.

Accordingly, a high copy number can be regarded as at least 6 copies per cell, at least 5 copies per cell, at least 4 copies per cell, at least 3 copies per cell or at least 2 copies per cell.

Considering the general full base pair length of genes in the first (micro)organism, the present copy inducible vectors preferably comprise genomic DNA fragments of at least 30 Kb, such as 35 Kb, 40 Kb, 45 Kb, 50 Kb, 60 Kb, 70 Kb, 80 Kb, 90 Kb or 100 Kb.

According to a especially preferred embodiment, in the present methods the group of first organisms comprises non-culturable species, the genomic DNA library is a meta-genomic DNA library and the second organism is a culturable species.

According to a most preferred embodiment of the present invention, in the present methods, the group of first organisms comprises non-culturable microorganism species, the genomic DNA library is a microorganism meta-genomic DNA library and the second organism is a culturable microorganism species.

The principles underlying the present invention will be further illustrated in the following examples which are not intended to limit the scope of the present invention being solely determined by the appended claims. In the examples, reference is made to the appended figures wherein,

FIG. 1: shows a schematic overview of the strategy to identify new bioactive genes, compounds and mechanisms. (Meta)genomic DNA is isolated and cloned into a copy-inducible vector. The (meta)genomic library is then transferred to the target organism (e.g. a pathogenic bacterium). The copy-number of the vector harboring the (meta)genomic DNA is then induced or not induced. The effects of the clone induction on the growth of the target organism are monitored for each of the individual clones. Those clones that exhibit a consistent adverse effect on growth or cause lysis of the target organism are further characterized by molecular and biochemical methods to identify the bioactive genes, antimicrobial mechanisms and compounds.

FIG. 2: is an example of different phenotypes of the cultures after induction of the copy-number of the vector carrying (meta)genomic DNA fragments. −: no induction, copy number is low. +: with induction, copy number is high. After induction of the copy-number of the vector, the following effects may occur: —No effect on growth of target organism; —Growth inhibition of the target organism; —Lysis of the cultured cells.

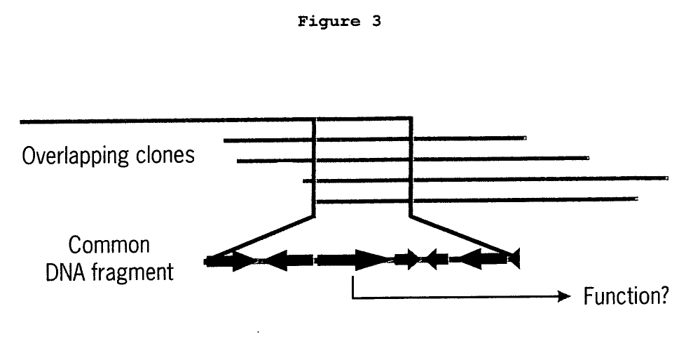

FIG. 3: shows a contig of overlapping clones that exhibit a similar phenotype (lysis or growth reduction). The clones share a common DNA fragment, on which a gene or genes/gene clusters are located that are responsible for the phenotype.

### EXAMPLES

In the following examples a method is demonstrated that allows for quick, effective and high-throughput screening of novel bioactive genes, compounds, mechanisms and molecular targets. The first step comprises the transfer of the (meta)genomic DNA library from culturable or non-culturable organisms directly into a target organism (e.g.

human, animal or plant pathogenic bacteria); the first principle underlying the present method is that the effect of the genes encoded by the transferred DNA on the growth of the target organism can be determined, thereby avoiding laborious screening procedures.

The principle underlying the present method is that the method allows for the regulation of the expression of the transferred (meta)genomic DNA. With the currently available methods, identification of antimicrobial genes, compounds and mechanisms is difficult especially when the production of the antibiotic compound is too low (no effect on growth) or too high (no growth at all). In the method, the copy-number of the expression vector used to transfer the (meta)genomic DNA into the target organisms can be manipulated and thereby also regulation of the biosynthesis of the bioactive compounds or mechanisms.

When the copy-number is low, the expression of the cloned genes and biosynthesis of the active compounds will be low and growth of the target organism will not, or not significant, be affected. By increasing the copy-number, gene expression and biosynthesis of bioactive compounds will increase and the effect on growth of the target organism can be determined.

### Example 1

### Materials and Methods

A genomic library was constructed from the soil-inhabiting bacterial strain Pseudomonas fluorescens SS101 (De Souza et al. 2003) by cloning relatively large (>50 Kb) DNA fragments in the copy-inducible vector pCC1BAC (EpiCentre Technologies). The genomic library was subsequently transferred into the corresponding host Escherichia coli EPI300-TiR (EpiCentre Technologies).

### Results and Discussion

After transfer of the genomic library of P. fluorescens strain SS101 into E. coli EPI300-TiR and subsequent induction of the copy-number of the vector, a clone was identified that resulted in lysis of the E. coli cells 4 hours after induction of the copy-number. Subsequent molecular analysis revealed that this clone contained a DNA insert of approximately 100-kb which was subsequently sequenced (MacroGen, South-Korea).

Sequence analysis of this 100-kb DNA fragment showed that this insert contains genes that encode for a pyocin, a small protein with specific antibacterial activity (Parret and De Mot, 2002; Denayer et al. 2007). No other obvious bioactive genes were found among the other genes present on the cloned DNA fragment.

These results suggest that E. coli is sensitive to the pyocin encoded by genes from P. fluorescens and that the antibiotic activity occurs only when the copy-number of the vector containing these genes is induced.

### Conclusion

This example shows that cloning and induction of (meta)genomic DNA in a host cell provides identification of genes, compounds and/or mechanisms with antimicrobial activities against the host organism. The use of copy-inducible vectors is an essential element and makes the screening procedure fast and more effective than methods currently used to discover new bioactive genes, compounds and mechanisms.

### Example 2

### Materials and Methods

A genomic library from a bacterium of which the genome is fully sequenced (i.e. Pseudomonas fluorescens SBW25; http://pseudo.bham.ac.uk/) was constructed by cloning relatively large DNA fragments (˜35 kb) in a copy-inducible vector (pCC1FOS; EpiCentre Technologies) and transferring the library into the corresponding host E. coli EPI300-TiR (EpiCentre Technologies). The size of the cloned DNA fragments was determined for 12 random clones and was on average 37 kb. Based on the average insert size, 15×96=1440 clones were screened, which corresponds to approximately 8 genome equivalents.

### Results and Discussion

The clones were grown overnight in 96-well plates and transferred in duplicate to 24-well plates. After 30 minutes of growth, the copy-number of the vector was induced or not induced according to the method and procedure schematically illustrated in FIG. 1.

After several hours of incubation, the optical density of the cultures was determined at a wavelength of 600 nm (OD600), which is a measure for bacterial growth. After 5 and 8 hours of incubation, the OD600 of each of the individual clones was assessed with a spectrophotometer. In the screening system used, the measured OD600 of non-induced cultures was on average 0.4-0.5, whereas copy-induced cultures averaged an OD600 of 0.3-0.4.

This relatively small growth reduction in induced cultures is most likely due to a higher overall DNA replication and enhanced protein synthesis in the host when the copy number of the clone is induced.

Taking into account this overall clone-induced growth reduction, we focused specifically on those clones that caused cell lysis and on clones that strongly reduced growth of the host (see FIG. 2). Those clones that visibly and adversely affected growth of the target organism (E. coli) after induction of the copy-number of the vector amounted to a total of 138 clones from a total of 1440.

The consistency of the phenotypes (i.e. growth inhibition or lysis) of these 138 clones was confirmed in two independent experiments, which resulted in a total of 95 clones with a clear and reproducible effect on growth; 33 clones (out of the final total of 95 clones) exhibited lysis of the E. coli cells (Table 1).

TABLE 1
OD600 (Optical Density measured at a wavelength of
600 nm) of clones reduced in growth or that caused
lysis. Based on the OD600, clones were categorized
in 5 groups (1-5). Clones belonging to category 5
did not show reduced growth but showed cell lysis
after 5 and/or 8-hours of incubation.

| | OD600 after | | |
|---|---|---|---|
| | induction | Number of clones | Lytic clones |
| category 1 | ≦0.1 | 9 | 1 |
| category 2 | 0.1 − 0.15 | 14 | 2 |
| category 3 | 0.15 − 0.2 | 32 | 1 |
| category 4 | 0.2 − 0.25 | 40 | 17 |
| category 5 | ≧0.25 | | 12 |
| total | | 95 | 33 |

For each of the 95 clones, the DNA-inserts were end-sequenced. By comparing the obtained sequences (both ends of the insert) with the genome sequence of the source organism (i.e. P. fluorescens SBW25), the sequence of the complete inserts of all 95 clones was obtained.

Based on this analysis, the average insert size was determined to be approximately 35 kb and the clone library corresponded to 7.5 genome equivalents. A total of 71 clones could be placed in 17 contigs that consisted of 2 to 8 clones each (see FIG. 3 for a schematic presentation of the strategy followed).

All clones belonging to category 1 as well as almost all lytic clones were present on these contigs. These results show that the new method is able to efficiently identify DNA fragments harboring genes that adversely affect growth of target organisms. The exact identity of these genes and their corresponding products can then be established, e.g. by identifying genes or gene clusters that are common among the clones belonging to a specific contig (FIG. 3).

For example, one of the lytic clones harbors genes encoding a pyocin similar to that previously identified in the SS101 lytic clone (see Example 1). The pyocin genes cover a total of approximately 15 kb; a relatively large sequence stretch, which can explain why the pyocin gene cluster was identified only once in our screen.

Another example is the presence of a lytic transglycosylase in the clones that show severe growth inhibition upon induction (category 1; Table 1). Intrinsically, lytic transglycosylases are involved in cell wall pore formation in Gram-negative bacteria that allows macromolecular transport (Koraimann, 2003).

Overexpression of a lytic transglycosylase may therefore lead to (complete) breakdown of the bacterial cell wall, and thereby growth is inhibited. Interestingly, lytic transglycosylases have been proposed as a potential target for novel antimicrobial compounds (Korsak et al. 2005).

Following the identification, these candidate genes or gene clusters can be subcloned and tested again for their effects on growth of the target organism. In case the effects of the subcloned genes or gene clusters is identical to that of the original clone, then the genes and metabolites or mechanisms responsible for the growth reduction or lysis can be further identified by, among others, chemical identification.

Another way of identifying the gene(s) responsible for growth inhibition or cell lysis of an induced clone is by creating a knock-out library from that particular clone by, for example, random transposon mutagenesis; the generated mutant clones can then be introduced in the host cells and tested for growth inhibition or the lytic phenotype.

The activity of the identified bioactive genes or antimicrobial compounds can also be tested against a panel of other target organisms (e.g. pathogenic bacteria, yeasts, fungi). In addition, the initial genomic library can also be transferred to and expressed in other target organisms or cell systems to determine if the biological activity is specific or broad-spectrum.

### REFERENCES

Alekshun M N and Levy S B (2007) Molecular mechanisms of antibacterial multidrug resistance. Cell 128: 1037-1050.
Béjá O, et al. and DeLong E F (2000) Construction and analysis of bacterial artificial chromosome libraries from a marine assemblage. Environmental Microbiology 2: 516-529.
Cegelski L, Marshall G R, Eldridge G R and Hultgren S J (2008) The biology and future prospects of antivirulence therapies. Nature Reviews Microbiology 6: 17-27.
Charpentier E, Anton A I, Barry P, Alfonso B, Fang Y and Novick R P (2004) Novel cassette-based shuttle vector system for Gram-positive bacteria. Applied and Environmental Microbiology 70: 6076-6085.
Cowan D A (2000) Microbial genomes—the untapped resource. Trends in Biotechnology 18: 14-16.
Denayer S, Matthijs S and Cornelis P (2007) Pyocin s2 (Sa) kills Pseudomonas aeruginosa strains via FpvA type I ferripyoverdine receptor. Journal Bacteriology 189: 7663-7668.
De Souza J T, De Boer M, De Waard P, Van Beek T A, and Raaijmakers J M (2003) Biochemical, genetic and zoosporicidal properties of cyclic lipopeptide surfactants produced by Pseudomonas fluorescens. Applied and Environmental Microbiology 69:7161-7172.
Handelsman J, Rondon M R, Brady S, Clardy J and Goodman R (1998) Molecular biological access to the chemistry of unknown soil microbes: a new frontier for natural products. Chemistry & Biology 5: R245-249.
Kim J-H and Mills D A (2007) Improvement of a nisin-inducible expression vector for use in lactic acid bacteria. Plasmid 58: 275-283.
Koraimann G (2003) Lytic transglycosylases in macromolecular transport systems of Gram-negative bacteria. Cellular and Molecular Life Sciences 60:2371-2388.
Korsak, D, Liebscher S and Vollmer, W (2005) Susceptibility and β-lactamse induction in murein hydrolase of Escherichia coli. Antimicrobial Agents and Chemotherapyl 49:404-1409.
Leveau, J H J (2007) The magic and menace of metagenomics: prospects for the study of plant growth-promoting rhizobacteria. European Journal of Plant Pathology 119:279-300.
McDevitt D and Rosenberg M (2001) Exploiting genomics to discover new antibiotics. Trends in Microbiology 9: 611-617.
Nordmann P, Naas T, Fortineau N and Poirel L (2007) Superbugs in the coming new decade; multidrug resistance and prospects for treatment of Staphylococcus aureus, Enterococcus spp. and Pseudomonas aeruginosa in 2010. Current Opinion in Microbiology 10: 436-440.
Osoegawa K, Woon P Y, Zhao B, Frengen E, Tateno M, Catanese J J and De Jong P (1998) An improved method for construction of bacterial artificial chromosome libraries. Genomics 52: 1-8.
Parret A H A and De Mot R (2002) Bacteria killing their own kind: novel bacteriocins of Pseudomonas and other gamma-proteobacteria. Trends in Microbiology 10:107-112.
Steele H L and Streit W R (2005) Metagenomics: advances in ecology and biotechnology. FEMS Microbiology Letters 247: 105-111.
Sukchawalit R, Vattanaviboon P, Sallabhan R and Mongkolsuk (1999) Construction and characterization of regulated L-arabinose-inducible broad host range expression vectors in Xanthomonas. FEMS Microbiology Letters 181: 217-223.
Wild J and Szybalski W (2004a) Copy-control pBAC/oriV vectors for genomic cloning. Pages 145-154. In: Methods in Molecular Biology vol. 267: Recombinant Gene Expression: reviews and protocols, Balbás P and Lorence A (ed.) Humana Press Inc., Totowa, N.J.
Wild J and Szybalski W (2004b) Copy-control tightly regulated expression vectors based on pBAC/oriV. Pages 155-166. In: Methods in Molecular Biology vol. 267: Recombinant Gene Expression: reviews and protocols, Balbás P and Lorence A (ed.) Humana Press Inc., Totowa, N.J.

1-14. (canceled)

15. A method for identifying one or more bioactive genes, comprising:
(a) introducing an expressible genomic DNA library derived from a first organism or a group of first organisms into a second organism, wherein said genomic DNA library is comprised in a copy inducible vector in said second organism, thereby providing a multitude of clones of said second organism capable of expressing at least a part of said genomic DNA library;
(b) growing said multitude of clones of said second organism at a low copy number of said vector and at a high copy number of said vector;
(c) identifying one or more clones of said second organism wherein said identification comprises identifying an altered growth characteristic between a clone of said second organism grown at the low copy number of said vector and at the high copy number of said vector;
(d) identifying in the one or more clones of said second organism identified in step (c) one or more genes of said first organism or said group of first organisms providing the altered growth characteristic, thereby identifying the one or more bioactive genes.

16. The method according to claim 15, wherein said altered growth characteristic is visually determined.

17. The method according to claim 15, wherein said altered growth characteristic at the high copy number, as compared to the growth characteristic at the low copy number, is selected from the group consisting of a reduced growth; cell lysis; and no growth.

18. The method according to claim 15, wherein said second organism is a microorganism.

19. The method according to claim 15, wherein said second organism is a pathogenic microorganism selected from the group consisting of bacteria, yeasts, fungi, nematodes, lower eukaryotes, and unicellular organisms.

20. The method according to claim 15, wherein said first organism or said group of first organisms is/are a microorganism(s).

21. The method according to claim 15, wherein said first organism or said group of first organisms is/are a microorganism(s) selected from the group consisting of bacteria, yeast, fungus, nematode, lower eukaryote, and unicellular organism.

22. The method according to claim 15, further comprising, after step (e), isolating said one or more bioactive genes.

23. The method according to claim 15, wherein said one or more bioactive genes are involved, or encode proteins which are involved, in degradation of xenobiotic compounds, regulation of cell metabolism, interfering with cell wall biogenesis, or cell wall integrity.

24. The method according to claim 15, wherein said one or more bioactive genes encodes a protein having an antibiotic activity for said second organism or capable of providing compounds with an antibiotic activity for said second organism.

25. The method according to claim 15, wherein said low copy number is 1 to 5 copies per cell.

26. The method according to claim 15, wherein said high copy number is at least 6 copies per cell.

27. The method according to claim 15, wherein said copy inducible vector comprises genomic DNA fragments of at least 30 kb.

28. The method according to claim 15, wherein said group of first organisms comprises non-culturable species and said genomic DNA library is a meta-genomic DNA library.
